(19) United States
(12) Patent Application Publication
(10) Pub. No.: US 2014/0104154 A1
(43) Pub. Date: Apr. 17, 2014

(54) INFORMATION OUTPUT APPARATUS FOR OUTPUTTING THE SAME INFORMATION AS ANOTHER APPARATUS AND METHOD

(71) Applicant: CASIO COMPUTER CO., LTD., Tokyo (JP)

(72) Inventor: Junichi YOSHIDA, Hamura-shi Tokyo (JP)

(73) Assignee: CASIO COMPUTER CO., LTD., Tokyo (JP)

(21) Appl. No.: 14/049,862

(22) Filed: Oct. 9, 2013

(30) Foreign Application Priority Data
Oct. 11, 2012 (JP) 2012-226169

(51) Int. Cl. G02F 1/1345

(52) U.S. Cl. CPC G02F 1/13452
USPC 345/107

(57) ABSTRACT

When electronic papers are mounted on an electronic pad in a random sorting order, display data stored in and displayed on the papers are read along with its IDs, and stored in an electronic paper management table in association with paper IDs. The order of the display data is specified with the IDs or the order of tables of contents, and a sorting order of the papers is detected based on overlap detection sensors of the papers. Display data respectively stored according to the detected sorting order of the papers are rewritten and stored in the order of the specified IDs or the tables of contents. A PC device outputs the same information as information output by another information output apparatus by obtaining and analyzing information output by the other information output apparatus, and by detecting an output source of the information and then accessing the output source.

### BACKGROUND OF THE INVENTION

1. Field of the Invention

The present invention relates to an electronic data processing apparatus for recording and outputting desired information on an electronic medium such as an electronic paper using, for example, a paper-like non-volatile display device, and a control program therefor.

2. Description of the Related Art

In recent years, a paper-like non-volatile display device called “electronic paper” has been developed. The electronic paper is a thin and flexible paper although it is not as thin and flexible as an actual paper, and has a display surface that displays and holds an image with no power supply. An image can be written in/erased from the electronic paper supplied with electric power. The electronic paper can display and hold various types of content such as a text and an image by being supplied with electric power.

The applicant filed a patent application regarding an electronic paper recording apparatus, wherein an electronic paper is placed on a pad and handwritten contents are input thereon, so that the handwritten contents can be displayed on the electronic paper (U.S. Pat. No. 8,068,098).

With this electronic paper recording apparatus, in a server-client system having a thin client as a combination of a pad and a paper, default screen data for the combination of a pad and an electronic paper is stored in the server in advance (virtual paper client), and the screen data for the combination can be read and displayed by the paper being placed on the pad. When a handwritten input is performed on screen data of the paper, a handwritten locus can be added to and stored on the screen data.

Note that a plurality of electronic papers can be layered and placed on the pad, where an uppermost electronic paper is detected to determine an electronic paper on which the screen data and the handwritten locus are to be displayed.

In addition, a data writing apparatus for an electronic paper changes display of the electronic paper from masked display (non-display) to display upon connection of a key unit having proper key data, or through input of proper key data. Further, even during the connection of the key unit, the display is returned to the masked display after the elapse of a predetermined time. This enables secret screen data to be protected by selecting display/non-display as needed (for example, see Japanese Patent Application Laid-Open No. 2009-157036).

The conventional electronic paper recording apparatus or data writing apparatus can determine an uppermost electronic paper among the plurality of electronic papers placed on the pad and control display/non-display of the screen data on that uppermost electronic paper.

However, each screen data on the plurality of electronic papers is displayed as default screen data for a combination with the pad. Therefore, in a case where screen data that constitute a series of contents are associated with the plurality of electronic papers, and the electronic papers are placed on a pad in a random sorting order, there is an inconvenience that the screen data on the electronic papers, which should be sequentially turned over and viewed by the user, are not in the correct order.

### SUMMARY OF THE INVENTION

The present invention has been made in view of the foregoing, and an objective of the invention is to provide an electronic data processing apparatus and a control program therefor. Even if a plurality of electronic media are connected in a random sorting order with a plurality of sequenced data respectively stored in the plurality of electronic media, the electronic data processing apparatus and the control program are capable of storing and outputting the data in the order corresponding to the sorting order after the connection.

The present invention is provided with the following configuration.

An electronic data processing apparatus according to the preset invention is on to which a plurality of electronic media is detachably connected, and includes:

a data obtaining unit configured to obtain data respectively stored in the plurality of electronic media;

a data order specifying unit configured to specify an order of the data obtained from the plurality of electronic media by the data obtaining unit;

a medium sorting order detection unit configured to detect a sorting order of the plurality of electronic media; and

a data rewriting unit configured to rewrite the data respectively stored in the plurality of electronic media in the order of the data specified by the data order specifying unit according to the sorting order of the plurality of electronic media detected by the medium sorting order detection unit.

According to an embodiment of the present invention, even if a plurality of electronic media is connected in a random sorting order with a plurality of sequenced data respectively stored in the plurality of electronic media, the data can be stored and output in the order corresponding to the sorting order after the connection.

### BRIEF DESCRIPTION OF THE DRAWING

FIGS. 1A and 1B are views illustrating an electronic paper recording apparatus and an electronic paper according to an embodiment of an electronic data processing apparatus of the present invention;

FIGS. 2A and 2B are views illustrating an electronic paper recording apparatus and an electronic paper according to an embodiment of the present invention;

FIGS. 3A and 3B are views illustrating configurations of the electronic paper in the electronic paper recording apparatus;

FIGS. 4A and 4B are views illustrating configurations of overlap detection sensors provided in the electronic papers of the electronic paper recording apparatus;

FIG. 5 is a view illustrating a plurality of electronic papers being placed in the electronic paper recording apparatus;

FIG. 6 is a block diagram illustrating a configuration of an electronic circuit in a case where the electronic paper recording apparatus is incorporated as a terminal of a cloud computing system on a network;

FIG. 7 is a table illustrating contents of an electronic paper management table;

FIG. 8 is a table illustrating contents of a display content storage unit;

FIG. 9 is a flowchart illustrating electronic pad processing with an electronic pad;

FIG. 10 is a flowchart illustrating overlap detection processing of the electronic pad;

FIG. 11 is a flowchart illustrating solo overlap detection processing associated with the overlap detection processing of the electronic pad; and

FIG. 12 is a flowchart illustrating content order specifying processing of the electronic pad.

### DETAILED DESCRIPTION OF THE PREFERRED EMBODIMENTS

An embodiment of the present invention will be described below with reference to the drawings.

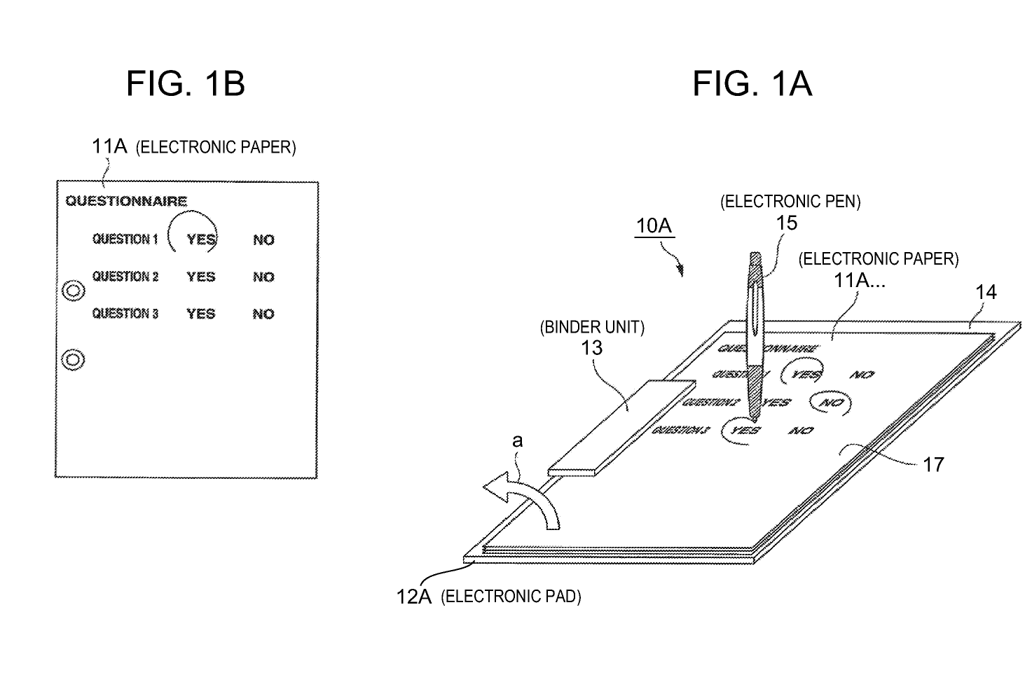

FIGS. 1A and 1B are views illustrating a configuration of an electronic paper recording apparatus (single-sided type) 10A according to an embodiment of an electronic data processing apparatus of the present invention. FIG. 1A is a perspective view illustrating an outer configuration, and FIG. 1B is a front view illustrating an extracted electronic paper (single-sided type) 11A.

The electronic paper recording apparatus (single-sided type) 10A includes a plurality of electronic papers (single-sided type) 11A, each of which has a non-volatile display device 17 on its surface, and an electronic pad (single-sided type) 12A on which the plurality of electronic papers 11A is layered. The electronic papers 11A are bound with the middle of a left side thereof clipped by a single-sided binder unit 13 provided in the middle of a left side of the electronic pad 12A.

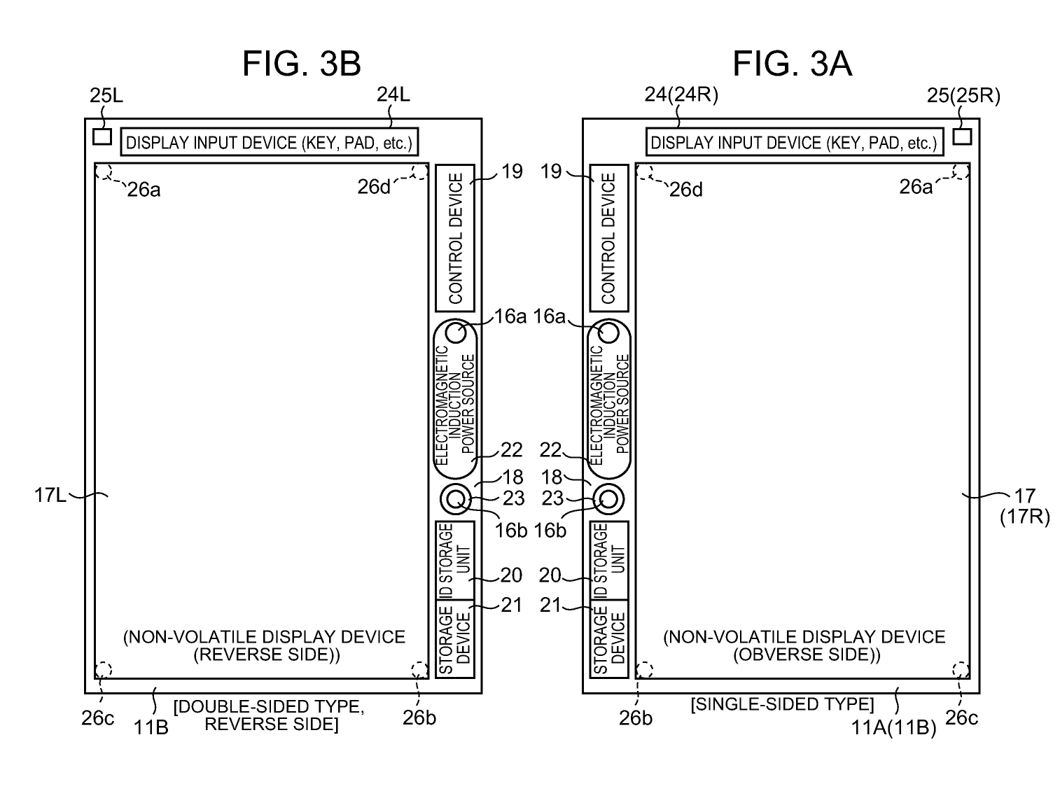

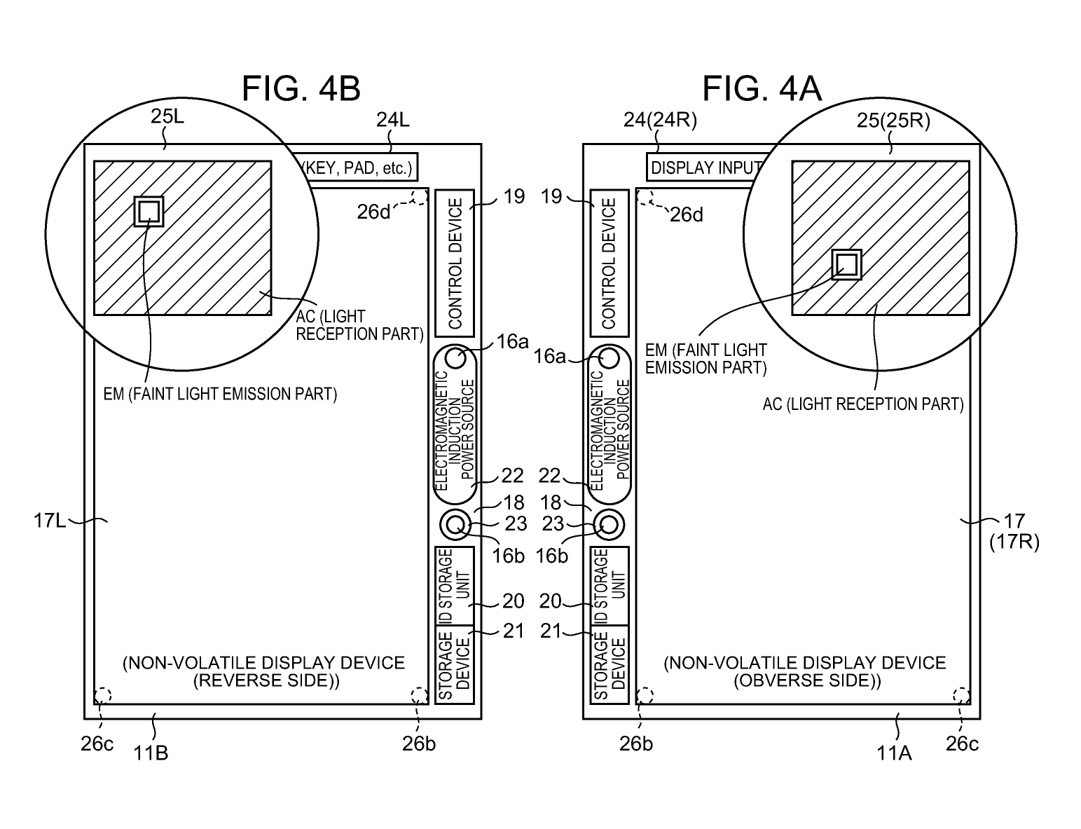

The electronic pad 12A includes, for example, an electromagnetic induction tablet 14 on its surface corresponding to a mounting surface of the electronic paper 11A, and detects, with the tablet 14, a coordinate position corresponding to a handwrite position written with an electronic pen 15 on an uppermost electronic paper 11A. Then, the electronic pad 12A allows display data corresponding to detected coordinates of the handwrite position or display data of various types of content obtained from an external information providing device to be stored in a display storage unit built in the electronic paper 11A through a contactless power supply unit and a contactless communication unit (described below, see FIGS. 3A to 4B) provided using the binder unit 13, and allows the non-volatile display device 17 of the electronic paper 11A to perform a display operation.

The non-volatile display device 17 of the electronic paper 11A is configured such that positively charged black particles and negatively charged white particles are alternately partitioned and sealed between transparent electrode plates in a matrix manner, and a black display is achieved by one electrode plate being negatively charged while a white display is achieved by the one electrode plate being positively charged. The electrode plate is charged with the polarity of a lastly applied voltage, and the display is held with no power supply.

This enables display not only of display data externally input through the electronic pad 12A and the binder unit 13 on the electronic paper 11A, but also of the handwritten data directly written with the electronic pen 15. Moreover, the electronic paper 11A can be treated in a similar manner to an ordinary paper by removing the electronic paper 11A from the electronic pad 12A, as illustrated by an arrow “a” in FIG. 1B.

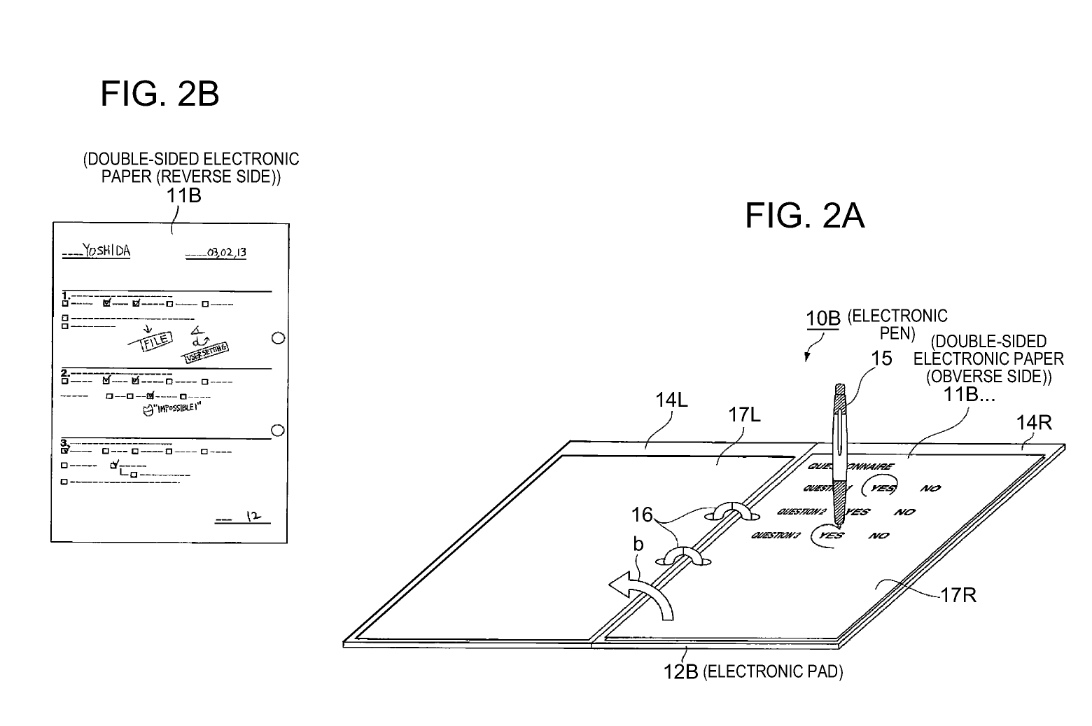

FIGS. 2A and 2B are views illustrating a configuration of an electronic paper recording apparatus (double-sided type) 10B according to an embodiment of the present invention. FIG. 2A is a perspective view illustrating an outer configuration, and FIG. 2B is a front view illustrating a reverse side of an extracted electronic paper (double-sided type) 11B.

Each of the plurality of electronic papers (double-sided type) 11B used in the electronic paper recording apparatus (double-sided type) 10B includes the above-described non-volatile display devices 17R and 17L on its obverse side and reverse side, respectively. The electronic papers 11B are bound with one end part of each electronic paper penetrated by a two-page spread binder unit 16 provided in the middle of a two-page spread electronic pad 12B.

The two-page spread electronic pad 12B includes, for example, electromagnetic induction tablets 14R and 14L on the mounting surfaces of the electronic paper 11B at the right and left parts of the two-page spread surface of the electronic pad 12B, respectively. The tablets 14R and 14L detect the coordinate positions corresponding to the handwrite position on the obverse side of the right uppermost electronic paper 11B and the handwrite position on the reverse side of the left uppermost electronic paper 11B written with the electronic pen 15. Then, the two-page spread electronic pad 12B allows display data corresponding to the detected coordinates of the handwrite positions on the obverse side and the reverse side or display data of various types of content obtained from an external information providing device to be stored in a display storage unit built in the electronic paper 11B through a contactless power supply unit and a contactless communication unit (described below, see FIGS. 3A to 4B) provided corresponding to the two-page spread binder unit 16, and allows the non-volatile display devices 17R and 17L on both sides of the electronic paper 11B to perform a display operation.

This enables display not only of the display data externally input through the electronic pad 12B and the two-page spread binder unit 16 on the obverse and reverse sides of the electronic paper (double-sided type) 11B, but also of the handwritten data directly written with the electronic pen 15 on the obverse and reverse sides. Moreover, the electronic paper 11B can be treated in a similar manner to an ordinary paper having obverse and reverse sides by removing the electronic paper 11B from the electronic pad 12B, as illustrated by an arrow “c” in FIG. 2B.

FIGS. 3A and 3B are views illustrating configurations of the electronic papers 11A and 11B of the electronic paper recording apparatuses 10A and 10B. FIG. 3A is a configuration diagram illustrating the electronic paper (single-sided type) 11A as viewed from the obverse side, and FIG. 3B is a configuration diagram illustrating the electronic paper (double-sided type) 11B as viewed from the reverse side.

Note that the configuration of the electronic paper (single-sided type) 11A as viewed from the obverse side is the same as that of the electronic paper (double-sided type) 11B as viewed from the obverse side.

The non-volatile display devices (obverse side) 17 (17R) and (reverse side) 17L are provided over approximately entire areas in the center of the electronic papers 11A and 11B, respectively. Further, a control device 19 including a flexible IC chip, an ID storage unit 20 that stores individual electronic paper IDs, and an (information) storage device 21 that stores display data are housed in a bind-in unit 18 and are used commonly for the obverse and reverse sides of the electronic paper.

Further, a contactless electromagnetic induction power source unit 22 is built in a surrounding area of one binder through-hole 16a provided in the middle of the bind-in unit 18 so as to be common to the obverse side and the reverse side. Furthermore, a contactless communication device 23 is built in a surrounding area of the other binder through-hole 16b so as to be common to the obverse side and the reverse side.

Furthermore, input devices 24 (24R), 24L using keys or touch pads are provided in upper parts on the obverse side of the electronic papers 11A and 11B and in an upper part on the reverse side of the electronic paper 11B. Overlap detection sensors 25 (25R) and 25L using optical sensors are provided at end parts of the upper part of the paper opposite to the bind-in unit 18.

FIGS. 4A and 4B are enlarged views illustrating configurations of the overlap detection sensors 25 provided in the electronic papers 11A and 11B of the electronic paper recording apparatuses 10A and 10B. FIG. 4A is an enlarged view illustrating configuration of the overlap detection sensor 25 (25R) of the electronic paper (single-sided type) 11A, and FIG. 4B is an enlarged view illustrating configuration of the enlarged overlap detection sensor 25L on the reverse side of the electronic paper (double-sided type) 11B.

Each of the overlap detection sensors 25 (25R) and 25L is configured by a combination of a faint light emission part EM and a light reception part AC. As illustrated in FIG. 4A, in the overlap detection sensors 25 (25R) on the obverse side of the electronic paper (single-sided type) 11A and the electronic paper (double-sided type) 11B, the faint light emission part EM is provided nearer an inner side within a light receiving region of the light reception part AC that is equivalent to a sensor region. Further, as illustrated in FIG. 4B, in the overlap detection sensor 25L on the reverse side of the electronic paper (double-sided type) 11B, the faint light emission part EM is provided nearer an outer side within a light receiving region of the light reception part AC that is equivalent to a sensor region.

For example, when a plurality of electronic papers 11A and 11B is layered and placed on the electronic pads 12A and 12B, first, the surface of a paper, the light reception part AC of which has received light, is determined to be positioned at the uppermost surface without causing the light emission parts EM of the overlap detection sensors 25 (25R) and 25L to emit light. Next, the light emission parts EM on the obverse side or the reverse side of the electronic papers 11A and 11B, the overlapping manner of which is unknown, are caused to emit light in a random order. As a result, the surface of a paper, the light reception part AC of which receives light every time the emission occurs, is determined to overlap the surface of the paper that is caused to emit light, and the surface of a paper, the light reception part AC of which receives no light, is determined to be positioned at the lowermost surface.

Accordingly, the sorting order of the plurality of electronic papers 11A and 11B placed on the electronic pads 12A and 12B can be determined

Then, calibration pointers 26a to 26d for detecting the displacement of the mounting positions of the electronic papers 11A and 11B with respect to the electronic pad tablets 14 (14R) and 14L are built in four corners of each of the non-volatile display devices (obverse side) 17 (17R) and (reverse side) 17L of the electronic papers 11A and 11B such that these calibration pointers are common to the obverse side and the reverse side of the electronic paper.

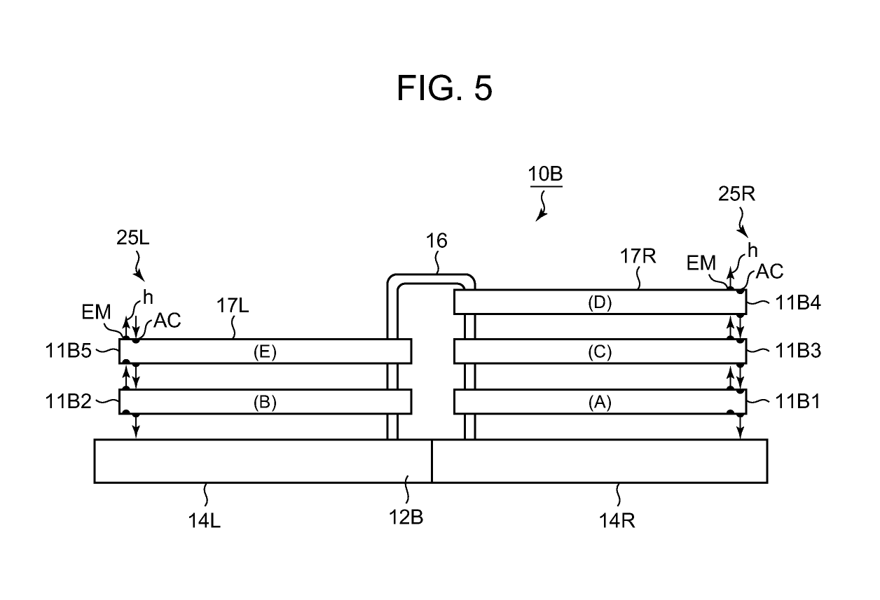

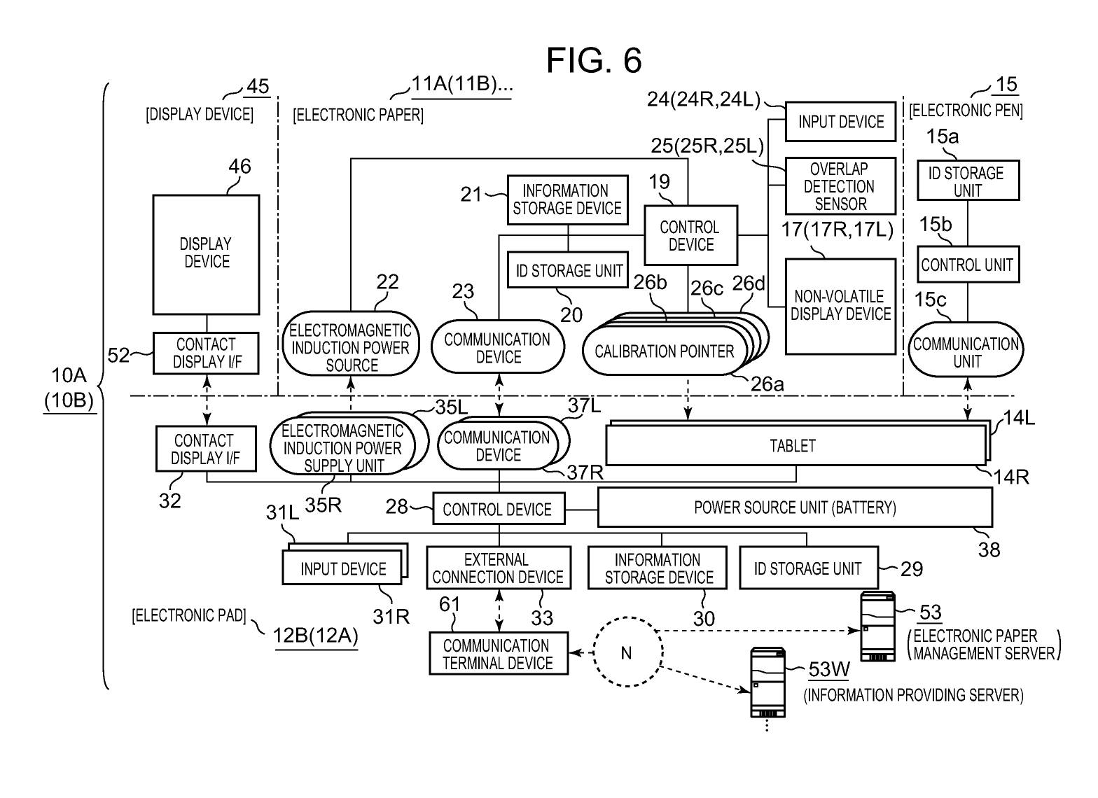

FIG. 5 is a view illustrating a specific example in which the plurality of electronic papers (double-sided type) 11B is placed in the electronic paper recording apparatus (double-sided type) 10B.

Note that, in FIG. 5, intervals are created between the electronic papers 11B for convenience. However, it is needless to say that, in reality, the electronic papers are layered without any intervals.

For example, under a state where two electronic papers 11B are layered in the order of (B)11B2→(E)11B5 on the left tablet 14L of the electronic pad (double-sided type) 12B, and three electronic papers 11B are layered in the order of (A)11B1→(C)11B3→(D)11B4 on the right tablet 14R, first, the light reception part AC of the reverse overlap detection sensor 25L of the electronic paper (E)11B5 on the left tablet 14L detects light reception and the electronic paper (E)11B5 is determined to be the “uppermost surface (not covered)”, and the tablet 14L detects the coordinate position of the paper with the calibration pointers 26a to 26d. Therefore, the electronic paper (E)11B5 is determined to be effective (active) on the left side of the electronic pad (double-sided type) 12B.

All of the three electronic papers (A)11B1, (C)11B3, and (D)11B4 layered on the right tablet 14R are detected by the tablet 14R with the calibration pointers 26a to 26d. Meanwhile, the light reception part AC of the obverse overlap detection sensor 25R of the electronic paper (D)11B4 detects light reception, and the electronic paper (D)11B4 is determined to be the “uppermost surface (not covered)”. Therefore, the electronic paper (D)11B4 is determined to be effective (active) on the right side of the electronic pad (double-sided type) 12B.

Further, as described above, the light emission parts EM on the obverse side or the reverse side of the electronic papers (A)11B1, (B)11B2, and (C)11B3, the overlapping manner of which is unknown, are caused to emit light in a random order. As a result, the surface of a paper, the light reception part AC of which has received light, is determined to overlap the surface of the paper that is caused to emit light, and the surface of a paper, the light reception part AC of which receives no light, is determined to be positioned at the lowermost surface.

Accordingly, in the specific example illustrated in FIG. 5, it can be determined that the five electronic papers (A)11B1 to (E)11B5 are mounted on the electronic pad 12B in the sorting order of (B)11B2→(E)11B5→(D)11B4→(C)11B3→(A)11B1.

Therefore, a control device 28 of the electronic pad 12B determines and manages the sorting order, the activeness/inactiveness, and the like based on overlap detection by the obverse and reverse overlap detection sensors 25R and 25L in association with the IDs (A), (B), . . . of the respective electronic papers 11B1, 11B2, . . . that are connected and communicated through the electromagnetic induction unit in a contactless manner. As a result, the control device 28 can allow the non-volatile display devices 17L and 17R having the ID of the effective (active) electronic paper 11B to display the display data of various types of content obtained from an externally connected information terminal, handwritten data written with the electronic pen 15 and detected by the right and left tablets 14L and 14R, text data input from input devices 31L and 31R, and the like, through the electromagnetic induction unit. Furthermore, the control device 28 can write, in the sorting order, the display data of a plurality of types of content sequenced by content IDs, tables of contents, or the like in the respective electronic papers 11B, and allow the respective electronic papers 11B to display the display data in the sorting order.

FIG. 6 is a block diagram illustrating a configuration of an electronic circuit in a case where the electronic paper recording apparatuses 10A and 10B are incorporated as terminals of a cloud computing system on a network N.

According to the configuration, a web browser is incorporated in the electronic pad 12B (12A), so that display data of arbitrary content selectively obtained from an information providing server 53W on the network N can be displayed on the electronic paper 11A (11B).

In the electronic circuit of the electronic paper 11A (11B), the non-volatile display device 17 (17R and 17L), the ID storage unit 20, the information storage device 21, the electromagnetic induction power source unit 22, the communication device 23, the input device 24 (24R and 24L), the overlap detection sensor 25 (25R and 25L), and the calibration pointers 26a to 26d are connected to the control device 19 including a low performance CPU that is a flexible IC chip computer, for example, as described with reference to FIGS. 3A and 3B.

In the electronic circuit of the electronic pad 12B (12A), the tablets 14R and 14L (14), an ID storage unit 29, an information storage device 30, input devices 31R and 31L (31), a contact display I/F 32, an external connection device 33, electromagnetic induction power supply units 35R and 35L (35), communication devices 37R and 37L (37), and a power source unit (battery) 38 are connected to the control device 28 including a low function CPU that is, for example, a flexible IC chip computer.

The electronic papers 11B (11A) are placed on the tablets 14R and 14L (14) and are bound on the electronic pad 12B (12A) with the binder unit 16 (13), as illustrated in FIGS. 1A to 2B. As a result, the electromagnetic induction power supply units 35R, and 35L (35) of the electronic pad 12B (12A) are electromagnetically connected to the electromagnetic induction power source unit 22 of the electronic paper 11B (11A) through the electromagnetic induction unit, and the communication devices 37R and 37L (37) of the electronic pad 12B (12A) are electromagnetically connected to the communication device 23 of the electronic paper 11B (11A).

The coordinates of electromagnetic induction signals generated from the calibration pointers 26a to 26d of the electronic paper 11B (11A) are detected by the tablets 14R and 14L (14) of the electronic pad 12B (12A), so that the mounting position of the electronic paper 11B (11A) in a plane direction with respect to the tablets 14R and 14L (14) is detected.

The electronic pen 15 includes an ID storage unit 15a, a control unit 15b, and a communication device 15c. The ID storage unit 15a stores a pen ID of the pen. The control unit 15b includes an IC chip and reads the pen ID stored in the ID storage unit 15a, and generates and outputs a code signal. The communication device 15c is provided with a coil that converts the code signal of the pen ID generated and output from the control unit 15b into an electromagnetic induction signal, and outputs the signal.

Program data used by the control device 19 to control the circuit units of the electronic paper 11A (11B) are stored in the information storage device 21. Display data for displaying data corresponding to an input of various types of content in the non-volatile display device 17 (17R and 17L), in addition to unique information that is specifications of the electronic paper 11A (11B), are also stored in the information storage device 21. The various types of content include not only a key operation input from the input device 24 (24R and 24L), but also a handwrite position detection input on the electronic pad 12B (12A) from the electronic pen 15, and a text/image from the externally connected information providing server 53W.

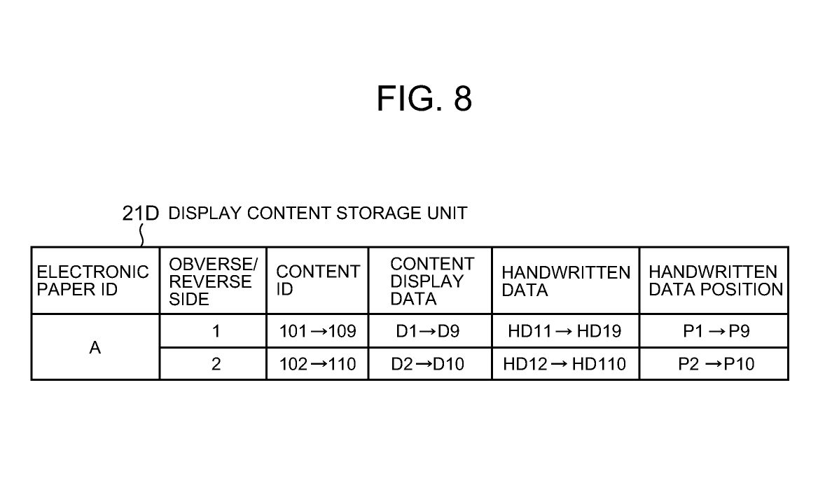

Therefore, the display data of content to be displayed by the non-volatile display device 17 (17R and 17L) of the electronic paper 11A (11B) are stored in the information storage device 21 of the electronic paper 11A (11B) in association with its content ID, and a storage region (display content storage unit 21D: see FIG. 8) for storing handwritten data in association with its position information is secured.

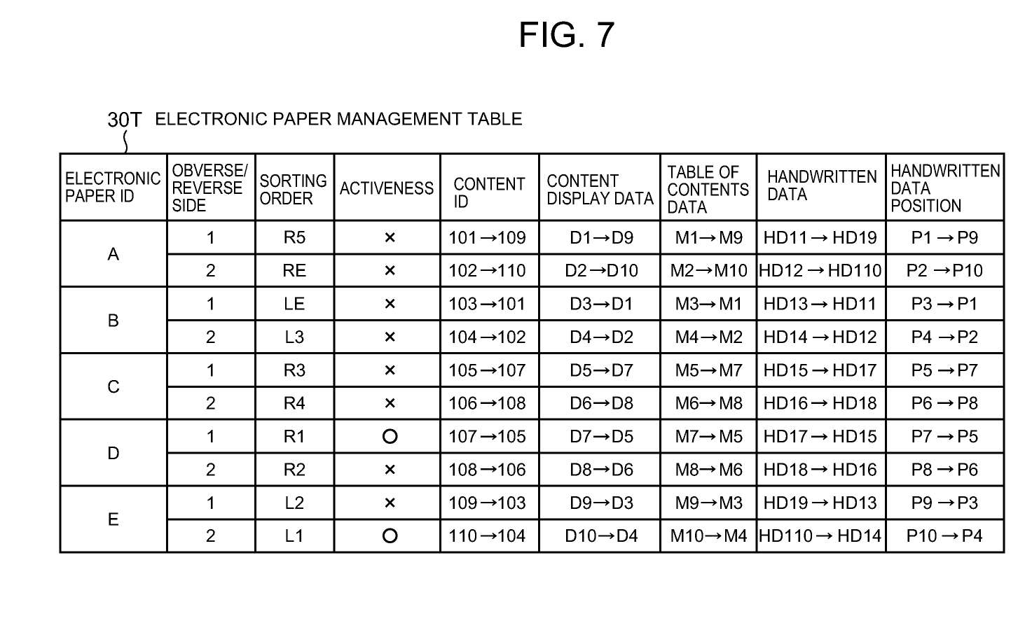

Program data (including a web browser) used by the control device 28 to control the circuit units of the electronic pad 12B (12A) are stored in the information storage device 30. Display data for transmitting and displaying data corresponding to inputs of various types of content to the currently effective (active) electronic paper 11B (11A), in addition to management information for managing the bound electronic papers 11B (11A), are also temporarily stored in the information storage device 30 (electronic paper management table 30T: see FIG. 7). The various types of content include not only a key operation input from the input devices 31R and 31L (31), but also a handwrite position detection input on the tablets 14R and 14L (14) from the electronic pen 15, and a text/image from the externally connected information providing server 53W.

A display device 45 is bound to the binder unit 16 (13) of the electronic pad 12B (12A) similarly to the electronic paper 11A (11B) as needed, and is connected to the pad via the contact display I/F 32 or 52. In the display device 45, data corresponding to an input of various types of content including a handwrite position detection input on the electronic pad 12B (12A) from the electronic pen 15, a text/image from the externally connected information providing server 53W, and the like can also be displayed on an LCD display device 46.

The information providing server 53W on the network N externally connected to the external connection device 33 of the electronic pad 12B (12A) may be connected to the external connection device 33 via a communication terminal device 61, such as a PC or a mobile phone, connected to the external connection device 33 by wired or wireless communication, or may be directly connected to the external connection device 33.

FIG. 7 is a table illustrating the contents of the electronic paper management table 30T stored and managed in the information storage device 30 of the electronic pad 12B (12A) of the electronic paper recording apparatuses 10A and 10B.

In the specific example of FIG. 7, the electronic paper management table 30T stored and managed by the double-sided electronic pad 12B will be illustrated.

When the electronic papers 11B are bound with the binder unit 16 of the electronic pad 12B and placed on the tablets 14R and 14L, the following information is stored in the electronic paper management table 30T. That is, the information includes unique information of the respective electronic papers 11B (electronic paper IDs/obverse and reverse codes) received through communication from the electronic papers 11B, sorting order information and active (effective) information determined based on the overlap detection information by the overlap detection sensors 25R and 25L, as well as display information (content ID/content display data/a table of contents data/handwritten data and its position) displayed on the obverse and reverse sides of the electronic paper 11B.

Among various types of information stored in the electronic paper management table 30T, the sorting order information and the active (effective) information based on the overlap detection information are updated and stored in real time.

Therefore, the sorting order of the currently effective (active) electronic paper 11B (11A) and the respective electronic papers 11B (11A) on the right and left sides of the electronic pad 12B (12A) are recognized with reference to the electronic paper management table 30T, and the input processing of an operation signal, the reading processing and writing processing of the display data, and the like based on the recognition are executed.

Note that the electronic paper management table 30T may be stored and managed in the externally connected electronic paper management server 53 on the network N in association with a pad ID of the electronic pad 12B (12A).

FIG. 8 is a table illustrating contents of the display content storage unit 21D stored and managed in the information storage device 21 of the electronic paper 11B (11A) of the electronic paper recording apparatus 10B (10A).

A specific example of FIG. 8 illustrates the display content storage unit 21D stored and managed in a double-sided electronic paper 11B1 (paper ID: A).

Display data of the various types of content are stored in association with content IDs thereof, and handwritten data is stored in association with its position information in the display content storage unit 21D, every time the electronic paper is mounted on the electronic pad 12B and the display data of the various types of content or the handwritten data is displayed on the active (effective) non-volatile display device 17R or 17L on the obverse side (1) or the reverse side (2) with power supply and display control from the electronic pad 12B.

Further, the content ID, the content display data, and the handwritten data and its position information stored in the display content storage unit 21D of each electronic paper 11B (11A) are rewritten and stored through rewriting processing based on the sorting order information when an instruction of “rearrangement” is given from the user, for example.

Next, operations of the electronic pads 12A and 12B of the electronic paper recording apparatuses 10A and 10B having the above-described configurations will be described.

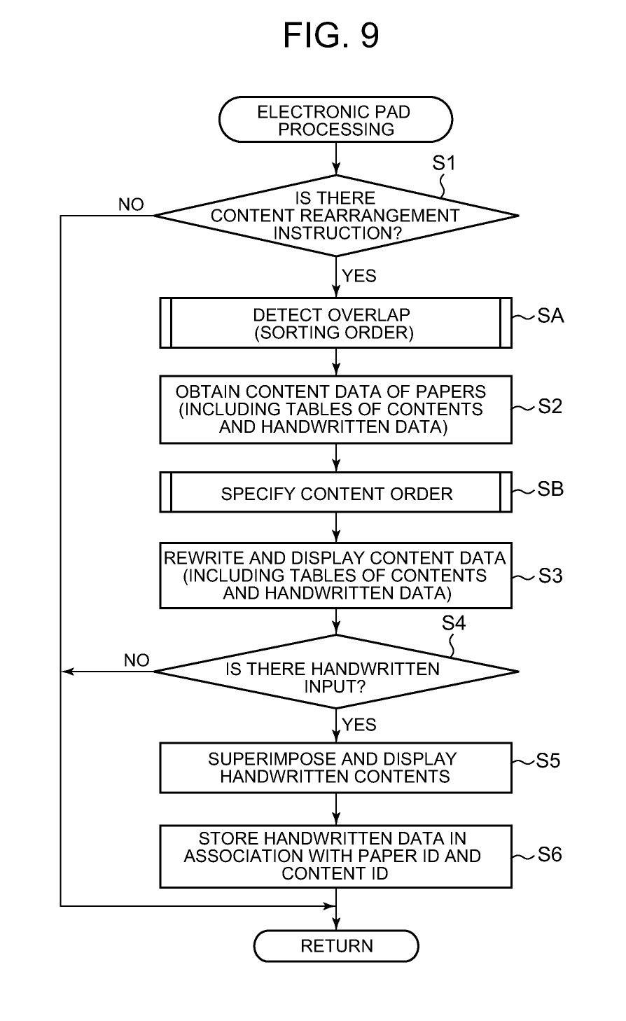

FIG. 9 is a flowchart illustrating electronic pad processing by the electronic pads 12A and 12B of the electronic paper recording apparatuses 10A and 10B.

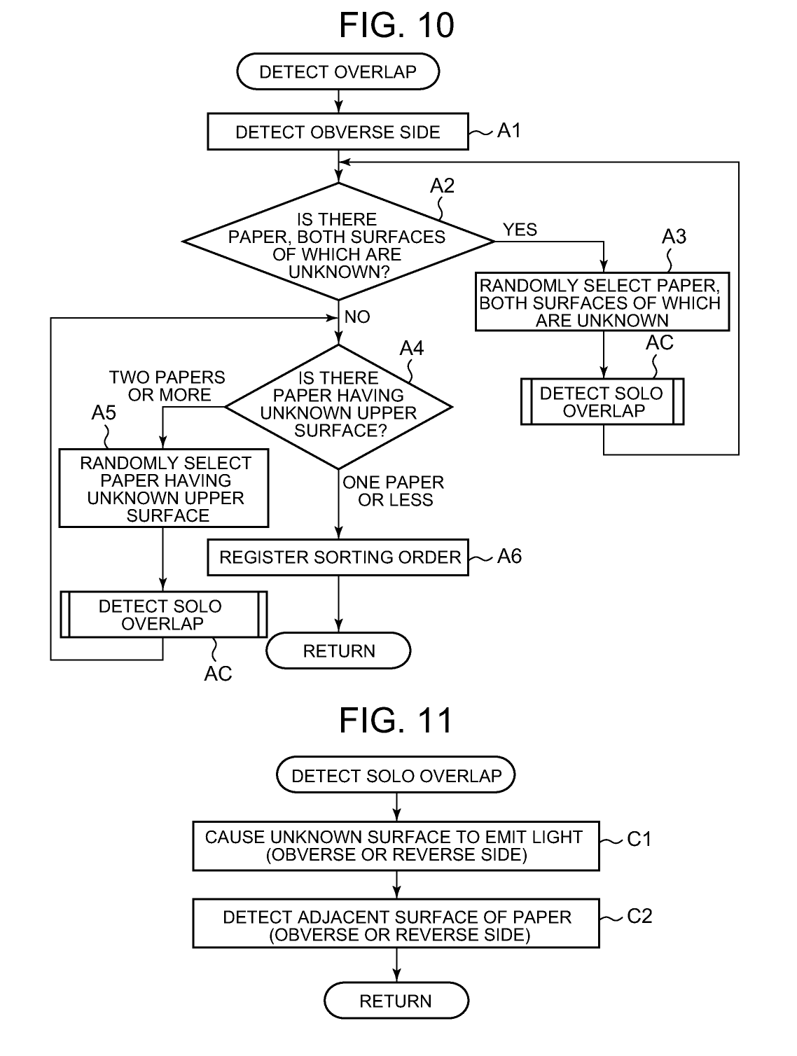

FIG. 10 is a flowchart illustrating overlap detection processing associated with the electronic pad processing of the electronic pads 12A and 12B.

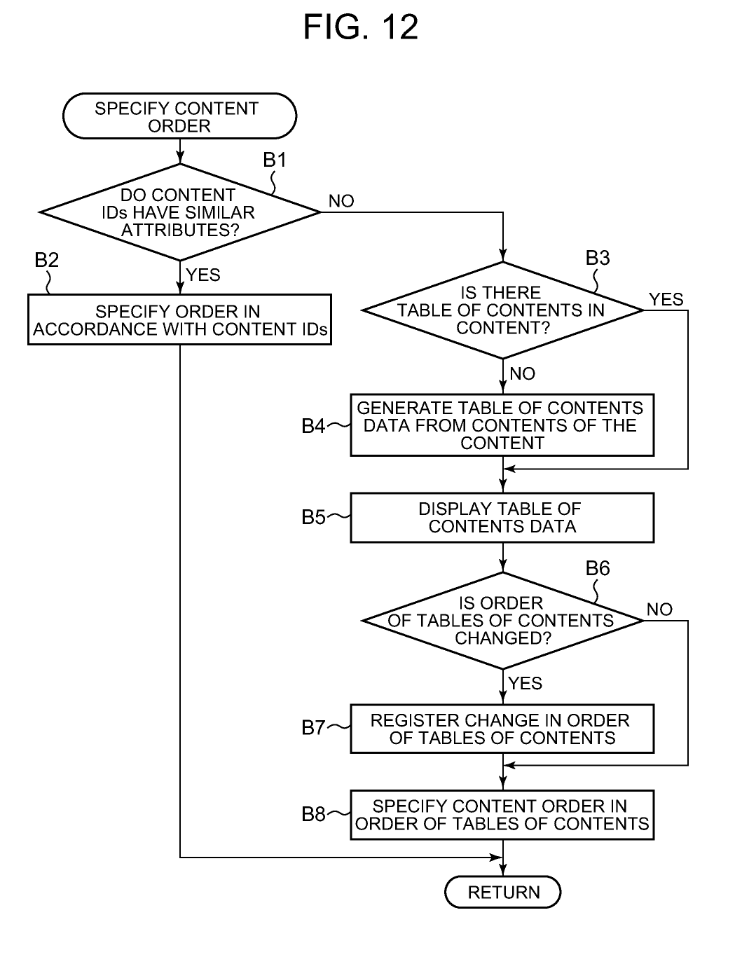

FIG. 11 is a flowchart illustrating solo overlap detection processing associated with the overlap detection processing of the electronic pads 12A and 12B.

FIG. 12 is a flowchart illustrating content order specifying processing associated with the electronic pad processing of the electronic pads 12A and 12B.

Note that, in the electronic pad processing, processing of obtaining, from the outside, display data of content arbitrarily selected by the user (for example, obtaining the display data from the information providing server 53W on the network N under the control of the web browser program stored in the information storage device 30) and causing the electronic papers 11A, 11B . . . mounted on the electronic pads 12A and 12B to display the display data is described in the prior Japanese Patent Application Nos. 2012-176079, 2012-193318, and 2012-193336 of the applicant, and description thereof is omitted herein.

Here, a specific example will be described, which shows the processing after the five electronic papers (A)11B1 to (E)11B5 are attached to the two-page spread binder unit 16 of the electronic pad (double-sided type) 12B in a random sorting order of (B)11B2, (E)11B5, (D)11B4, (C)11B3, and (A)11B1 from the top, and the two electronic papers (B)11B2 and (E)11B5 among them are turned over to the left tablet 14L, as illustrated in FIG. 5. In this case, the display data (obverse side: D1/reverse side: D2) to (obverse side: D9/reverse side: D10) of a series of content IDs (obverse side: 101/reverse side: 102) to (obverse side: 109/reverse side: 110) arbitrarily obtained by the user are sequentially stored and held in the five electronic papers (double-sided type) (A)11B1 to (E)11B5.

That is, in a case where the five electronic papers (A)11B1 to (E)11B5 are mounted on the electronic pad 12B in a random sorting order, when the electronic papers (B)11B2, (E)11B5, (D)11B4, (C)11B3, and (A)11B1 are turned over and the content display data respectively displayed thereon are browsed as illustrated in FIG. 5, the order of the content is of course random and it is difficult to browse the content.

Therefore, after the “rearrangement” of the displayed content on the electronic papers (A)11B1 to (E)11B5 is instructed in response to a user operation of the input devices 31R and 31L (step S1 (Yes)), the processing moves on to the overlap (sorting order) detection processing of FIGS. 10 and 11, based on the electronic paper IDs (A) to (E) read from the ID storage units 20 of the electronic papers (A)11B1 to (E)11B5 through the communication devices 23 (step SA).

In the overlap (sorting order) detection processing, first, it is determined by the control device 28, through the communication devices 37R and 37L of the electronic pad 12B, whether light reception signals are output from the light reception parts AC of the overlap detection sensors 25R and 25L (see FIGS. 4A and 4B) of the electronic papers (A)11B1 to (E)11B5. The reverse side “2” of the electronic paper (E)11B5 that is determined to output a light reception signal is detected as the left-side uppermost surface on the pad, and the obverse side “1” of the electronic paper (D)11B4 that is determined to output a light reception signal is detected as the right-side uppermost surface on the pad. The detection information at this time is temporarily stored (step A1).

Then, in a case where it is determined that there are electronic papers (A)11B1 to (C)11B3, both surfaces of which are unknown (step A2 (Yes)), any of these electronic papers is randomly selected (step A3), and the processing moves on to the solo overlap detection processing in FIG. 11 (step AC).

Then, the light emission part EM of the obverse or reverse overlap detection sensor 25R or 25L (see FIGS. 4A and 4B) of the selected electronic paper is driven and caused to emit light through the communication devices 37R and 37L and the electromagnetic induction power supply units 35R and 35L (step C1).

It is then determined by the control device 28, through the communication devices 37R and 37L, whether the light reception signals are output from the light reception parts AC of the overlap detection sensors 25R and 25L of the electronic papers other than the driven and light-emitting electronic paper. The surface of an electronic paper, which is determined to output the light reception signal, is detected as an adjacent surface of the surface of the driven and light-emitting electronic paper, and the detection information is temporarily stored (step C2).

More specifically, when, for example, the electronic paper (A)11B1 is selected from among the electronic papers (A)11B1 to (C)11B3, both surfaces of which are unknown, and the light emission part EM of the obverse overlap detection sensor 25R of the electronic paper (A)11B1 is driven and caused to emit light, the light reception signal is output from the light reception part AC of the reverse overlap detection sensor 25L of the electronic paper (C)11B3, and the electronic paper (C)11B3 is detected as an adjacent surface.

At this point, both surfaces of the electronic paper (B)11B2 remain unidentified. When the light emission part EM of the obverse overlap detection sensor 25R of the electronic paper (B)11B2 is driven and caused to emit light (step A2 (Yes) A3 C1), it is determined that the light reception signal is not output from any light reception part AC of the overlap detection sensors 25R and 25L of the other electronic papers (A)11B1, and (C)11B3 to (E)11B 5. Therefore, the electronic paper (B)11B2 is detected as the left-side lowermost surface on the pad, and the detection information is temporarily stored (step C2).

Then, at this point, the obverse side of the electronic paper (B)11B2 is determined to be the left-side lowermost surface on the pad, the reverse side of the electronic paper (E)11B5 is determined to be the left-side uppermost surface on the pad, the obverse side of the electronic paper (D)11B4 is determined to be the right-side uppermost surface on the pad, and the obverse side of the electronic paper (A)11B1 is determined to be the surface adjacent to the reverse side of the electronic paper (C)11C3.

Accordingly, it is determined that there is no electronic paper, both surfaces of which are unknown (step A2 (No)). Next, when it is determined that there are the electronic papers (C)11B3 and (E)11B5, upper surfaces of which are unidentified (step A4 (2 papers or more)), any of these electronic papers is randomly selected (step A5), and the processing moves on to the solo overlap detection processing in FIG. 11 (step AC).

More specifically, when, for example, the electronic paper (C)11B3 is selected from among the electronic papers (C)11B3 and (E)11B5, upper surfaces of which are unidentified, and the light emission part EM of the obverse overlap detection sensor 25R on the electronic paper (C)11B3 is driven and caused to emit light (step C1), the light reception signal is output from the light reception part AC of the reverse overlap detection sensor 25L on the electronic paper (D)11B4, and the electronic paper (D)11B4 is detected as an adjacent surface (step C2).

Then, it is determined that the electronic paper having an unidentified upper surface is one or less, including the electronic paper (E)11B5 (step A4 (1 paper or less)). At this point, therefore, the obverse side of the electronic paper (E)11B5 is detected as a surface adjacent to the reverse side of the electronic paper (B)11B2.

Accordingly, pieces of information L1 (uppermost surface), L2, L3, and LE (lowermost surface) are registered as the sorting order information of the electronic paper management table 30T, as illustrated in FIG. 7. The pieces of information L1, L2, L3, and LE indicate that the reverse and obverse sides of the electronic paper (E)11B5, and the reverse and obverse sides of the electronic paper (B)11B2 are sequentially overlapped in this order from the top on the left side (14L) of the pad. Similarly, pieces of information R1 (uppermost surface), R2, R3, R4, R5, and RE (lowermost surface) are registered as the sorting order information of the electronic paper management table 30T (step A6). The pieces of information R1, R2, R3, R4, R5, and RE indicate that the obverse and reverse sides of the electronic paper (D)11B4, the obverse and reverse sides of the electronic paper (C)11B3, and the obverse and reverse sides of the electronic paper (A)11B1 are sequentially overlapped in this order from the top on the right side (14R) of the pad.

Note that, in the electronic paper recording apparatus 10B of the present embodiment, first, the obverse side of the electronic paper (double-sided type) 11B faces upward when the electronic paper 11B is placed on the right side (14R) of the electronic pad 12B and the bind-in unit 18 is positioned at the left end of the electronic paper 11B. Then, the reverse side of the electronic paper 11B faces upward when the electronic paper 11B is turned over to the left side (14L) of the electronic pad 12B and the bind-in unit 18 is positioned at the right end of the electronic paper 11B. Therefore, as the overall sorting order of the plurality of electronic papers (A)11B1 to (E)11B5 placed on the electronic pad 12B in the electronic paper management table 30T, when there are the electronic papers (B)11B2 and (E)11B5 turned over to the left side (14L) of the pad, the obverse side of the electronic paper (B)11B2 that is a lowermost surface LE is recognized as a head surface. Then, when there are the electronic papers (A)11B1, (C)11B3, and (D)11B4 placed on the right side (14R) of the pad, the reverse side of the electronic paper (A)11B1 that is a lowermost surface LE is recognized as a tail surface.

In this way, the sorting order of all the electronic papers (A)11B1 to (E)11B5 placed on the electronic pad 12B is determined and registered in the electronic paper management table 30T through the overlap (sorting order) detection processing (step SA). After that, the content IDs (101) to (110) and display data (D1) to (D10) thereof, the handwritten data (HD11) to (HD110) and position information (P1) to (P10) thereof (the tables of contents data (M1) to (M10) as well, if there is the tables of contents data), which are stored in the display content storage units 21D of the electronic papers (A)11B1 to (E)11B5, are read and obtained through the communication devices 37L and 37R, and stored in the electronic paper management table 30T (see FIG. 7) (step S2).

Then, the processing moves on to the content order specifying processing in FIG. 12 (step SB).

In the content order specifying processing, first, it is determined whether the content IDs (101) to (110) of the electronic papers (A)11B1 to (E)11B5 stored in the electronic paper management table 30T have similar attributes (step B1).

Here, when it is determined that the content IDs (101) to (110) of the electronic papers (A)11B1 to (E)11B5 have similar attributes (step B1 (Yes)), the order of content thereof is specified according to the content IDs (101) to (110) (step B2). That is, in this case, the order is specified in the order of the content IDs (101), (102) . . . (109), and (110).

Meanwhile, when it is determined that the content IDs of the electronic papers 11B stored in the electronic paper management table 30T do not have a similar attribute (step B1 (No)), it is determined whether the tables of contents data (M) are stored in association with the content IDs (step B3).

Here, as illustrated in FIG. 7, when it is determined that the tables of contents data (M1) to (M10) of the content are stored (step B3 (Yes)), the list of the tables of contents data (M1) to (M10) and a message that notifies the user of presence/absence of change in the order of the tables of contents are displayed, for example, in the obverse non-volatile display device 17R of the electronic paper (D)11B4 placed on the right side (14R) of the pad and recognized as the uppermost surface (R1) (active) from the control device 28 through the communication device 37R (step B5).

Meanwhile, when it is determined that the tables of contents data (M) are not stored in association with the content IDs in the electronic paper management table 30T (step B3 (No)), corresponding tables of contents data (M) are generated and stored based on the contents of the display data (D) stored in association with the content IDs (step B4). Similarly, the list of the tables of contents data (M) and a message that notifies the user of presence/absence of change in the order of the tables of contents are displayed, for example, in the obverse non-volatile display device 17R of the electronic paper (D)11B4 placed on the right side (14R) of the pad and recognized as the uppermost surface (R1) (active) from the control device 28 through the communication device 37R (step B5).

Note that processing of automatically generating the table of contents from document data having a plurality of pages is known, and description thereof is omitted.

Then, in the list of the tables of contents data (M) displayed on the electronic paper (D)11B4 as the uppermost surface (R1) placed on the right side (14R) of the pad, when the order of the tables of contents data (M) is specified in response to a user operation with the display input device 24R or the electronic pen 15, and the change in the order is instructed (step B6 (Yes)), changed tables of contents data (M1) to (M10) are registered in association with the corresponding content IDs (101) to (110) in the electronic paper management table 30T (step B7).

Meanwhile, in the list of the tables of contents data (M) displayed on the electronic paper (D)11B4, when no change in the order of the tables of contents data (M) is instructed (step B6 (No)), the order of the tables of contents data (M1) to (M10) stored in association with the content IDs is maintained.

Then, the order of content is specified in accordance with the order of the tables of contents data (M1) to (M10) stored in the electronic paper management table 30T (step B8).

In this way, in the content order specifying processing, when the order of the respective pieces of content stored in the electronic paper management table 30T is specified in accordance with the order of the content IDs (101) to (110), or in accordance with the order of the tables of contents data (M1) to (M10) (step SB), the respective pieces of content are rewritten and changed according to the current sorting order (LE→L3→L2→L1→R1→R2→R3→R4→R5→RE) of the electronic papers (A)11B1 to (E)11B5 (step S3).

That is, in the present embodiment, as illustrated in FIG. 7, the respective pieces of content [the content IDs (101 to 110), the content display data (D1 to D10), the handwritten data (HD11 to HD110), and the handwrite position data (P1 to P10)] currently stored in the electronic paper management table 30T according to the order of the paper IDs (A to E) of the electronic papers (A)11B1 to (E)11B5 are rewritten and stored according to the sorting order (LE→L3→L2→L1→R1→R2→R3→R4→R5→RE) of the electronic papers (A)11B1 to (E)11B5, and are also stored in the display content storage units 21D (see FIG. 8) of the respective electronic papers (A)11B1 to (E)11B5 through the communication devices 37L and 37R.

Accordingly, the content stored in each of the electronic papers (A)11B1 to (E)11B5 and displayed thereon is rewritten and displayed according to the sorting order (B)11B2, (E)11B5, (D)11B4, (C)11B3, and (A)11B1 of the electronic papers (A)11B1 to (E)11B5 placed on the electronic pad 12B, as illustrated in FIG. 5.

Following that, on the obverse side of the electronic paper (D)11B4 as the uppermost surface that is placed on the right side (14R) and is active, for example, when a handwriting input is performed with the electronic pen 15, and position data of the handwriting is detected by the tablet 14R (step S4 (Yes)), a locus associated with the handwriting input is superimposed and displayed on the content display data (D5), which is being displayed on the obverse side of the electronic paper (D)11B4, as additional data through the communication device 37R, and is stored in the display content storage unit 21D (step S5).

Then, the handwritten data and the position information associated with the handwriting input are stored in the electronic paper management table 30T of the electronic pad 12B as handwritten data (HD15) and position information thereof (P5) that are associated with the active obverse side “1” of the electronic paper (D)11B4 and an content ID (105) (step S6).

Therefore, according to the displayed content rearrangement function of the electronic pads 12A and 12B of the electronic paper recording apparatuses 10A and 10B having the above configuration, when a plurality of electronic papers (A)11B1 to (E)11B5 is mounted on the electronic pad 12B in a random sorting order, the content display data (D1 to D10) stored in the display content storage units 21D of the electronic papers (A)11B1 to (E)11B5 and displayed on the non-volatile display devices 17R and 17L are read and obtained along with the corresponding content IDs (101 to 110), and are stored in the electronic paper management table 30T in association with the electronic paper IDs (A to E).

Then, the order of the obtained content display data (D1 to D10) is specified with the order of the content IDs (101 to 110) or the order of the tables of contents data (M1 to M10). The sorting order (B, E, D, C, A) of the electronic papers (A)11B1 to (E)11B5 mounted on the electronic pad 12B is determined based on the overlap detection sensors 25R and 25L provided in the electronic papers (A)11B1 to (E)11B5.

Then, the content display data (D3, D4/D9, D10/D7, D8/D5, D6/D1, D2) stored in and displayed on the electronic papers (A)11B1 to (E)11B5 according to the determined sorting order (B→E→D→C→A) thereof are rewritten to (D1, D2→D3, D4→D5, D6→D7, D8→D9, D10) and stored according to the specified order of the content IDs (101 to 110) or the specified order of the tables of contents data (M1 to M10).

Therefore, even if the plurality of electronic papers (A)11B1 to (E)11B5 is mounted on the electronic pad 12B in a random sorting order under a state where the content display data (D1 to D10) sequenced in accordance with identifiers and contents unique to the content are stored in the plurality of electronic papers (A)11B1 to (E)11B5, the content display data (D1 to D10) can be displayed in an easily browsable manner by being rewritten and stored in the order corresponding to the sorting order (B→E→D→C→A) after the mounting.

In addition, the overlap detection sensors 25R and 25L provided in the electronic papers (A)11B1 to (E)11B5 are configured as a combination of the light emission part EM and the light reception part AC at positions facing the obverse and reverse sides of the papers under a state where the electronic papers (A)11B1 to (E)11B5 are layered and mounted on the electronic pad 12B. The overlap detection sensors 25R and 25L determine the obverse side of the electronic paper (D)11B4, which outputs the light reception signal from the light reception part AC without causing any light emission part EM of the overlap detection sensors 25R and 25L to emit light, as the uppermost surface on the right side (14R) of the pad, and determine the reverse side of the electronic paper (E)11B5 as the uppermost surface on the left side (14L) of the pad.

Then, the light emission parts EM of the overlap detection sensors 25R and 25L facing unknown surfaces of the electronic papers are caused to sequentially emit light in each of the electronic papers (A)11B1 to (E)11B5. The surface of the electronic paper, the light reception part AC of which outputs the light reception signal in response to the light emission, is detected as an overlapped surface, so that the overall sorting order (B→E→D→C→A) of the electronic papers (A)11B1 to (E)11B5 can be determined

In addition, the tables of contents data (M1 to M10) of the respective content display data (D1 to D10) obtained from the electronic papers (A)11B1 to (E)11B5 are generated in accordance with the contents of the display data (D1 to D10), and the order of the tables of contents data (M1 to M10) can be listed on the active electronic paper (D)11B4, which is being mounted as the uppermost surface, and can be changed in response to a user operation. Therefore, the content display data (D1 to D10) that can be rewritten according to the sorting order (B→E→D→C→A) of the electronic papers (A)11B1 to (E)11B5 can be rewritten in the order of the tables of contents data arbitrarily changed by the user, whereby the content display data can be displayed on the electronic papers on the electronic pad 12B in a more easily browsable manner.

Note that, in the above-described embodiments, a configuration has been employed in which the sorting order of the plurality of electronic papers 11B (11A) mounted on the electronic pad 12B (12A) is determined based on the overlap detection by the overlap detection sensors 25R and 25L provided in the electronic papers 11B (11A). However, a configuration may be employed in which the order of mounting the electronic papers 11B (11A) on the electronic pad 12B (12A) is detected and the sorting order thereof is determined

Further, in the above-described embodiments, a configuration has been employed in which, when a plurality of electronic papers 11B (11A) is mounted on the electronic pad 12B (12A), the order of the content display data D1, D2, . . . stored and displayed in the electronic papers 11B (11A) is rewritten according to the sorting order of the mounted electronic papers 11B (11A), and therefore, the electronic papers can be easily browsed by the user. However, a configuration may be employed in which, when a plurality of electronic media including, for example, a USB memory is connected to a data reproduction device for the media in an arbitrary sorting order, data stored in the respective electronic media are rewritten and arranged according to the sorting order of the electronic media, and are reproduced in a proper order.

Note that the techniques of the processing by the electronic data processing apparatus described in the embodiments, that is, the electronic pad processing illustrated in the flowchart of FIG. 9, the overlap detection processing (SA) associated with the electronic pad processing and illustrated in the flowchart of FIG. 10, the solo overlap detection processing (AC) associated with the overlap detection processing and illustrated in the flowchart of FIG. 11, and the content order specifying processing (SB) associated with the electronic pad processing and illustrated in the flowchart of FIG. 12 can be stored in a medium of an external recording device such as a memory card (a ROM card, a RAM card, or the like), a magnetic disk (a floppy disk, a hard disk, or the like), an optical disk (a CD-ROM, a DVD, or the like), or a semiconductor memory, and can be distributed as programs executable by a computer.

Then, a computer (control unit) of an electronic device, to which a plurality of electronic media can be detachably connected, reads the programs stored in the medium of the external recording device in a storage device, and the operation is controlled by the read programs, so that the data rewriting (rearrangement) function described in the embodiments can be realized, and similar processing by the above-described techniques can be executed.

Further, data of the programs for realizing the above-described techniques can be transmitted over the communication network (N) as a form of a program code. The data of the programs may be incorporated in the electronic device, to which a plurality of electronic media can be detachably connected, from a computer apparatus (program server) connected to the communication network (N), and may be stored in the storage device, whereby the above-described data rewiring (rearrangement) function can be realized.

The present invention is not limited to the above-described embodiments, and various modifications can be made without departing from the spirit and scope of the invention in embodiment stages. Further, the above-described embodiments include inventions in various stages, and various inventions can be extracted by an appropriate combination of a plurality of disclosed constituent elements. For example, even if some constituent elements are deleted from all the constituent elements described in the embodiments, or some constituent elements are combined in a different form, the configurations, in which the constituent elements are deleted or combined, may be extracted as an invention as long as the problems described in SUMMARY OF THE INVENTION can be solved and the effects described in SUMMARY OF THE INVENTION can be obtained.

1. An electronic data processing apparatus to which a plurality of electronic media is detachably connected, comprising:
a data obtaining unit configured to obtain data respectively stored in the plurality of electronic media;
a data order specifying unit configured to specify an order of the data obtained from the plurality of electronic media by the data obtaining unit;
a medium sorting order detection unit configured to detect a sorting order of the plurality of electronic media; and
a data rewriting unit configured to rewrite the data respectively stored in the plurality of electronic media in the order of the data specified by the data order specifying unit according to the sorting order of the plurality of electronic media detected by the medium sorting order detection unit.

2. The electronic data processing apparatus according to claim 1,
wherein the data order specifying unit includes an order information determination unit configured to determine whether or not order information indicating the order of the data is included in the data obtained from the plurality of electronic media by the data obtaining unit, and
when it is determined by the order information determination unit that the order information is included in the data, the data order specifying unit specifies the order of the data according to the order information.

3. The electronic data processing apparatus according to claim 1,
wherein the data order specifying unit includes a data order changing unit configured to change the order of the data obtained from the plurality of electronic media by the data obtaining unit in response to a user operation, and
the data order specifying unit specifies the order of the data according to the order changed by the data order changing unit.

4. The electronic data processing apparatus according to claim 1,
wherein the plurality of electronic media each includes an adjacency detection sensor configured to mutually detect presence/absence of an adjacent electronic medium, and
the medium sorting order detection unit detects the sorting order of the plurality of electronic media based on identification information of the plurality of electronic media and detection information indicating the presence/absence of an adjacent electronic medium for each electronic medium, the detection information being detected by the adjacency detection sensor.

5. The electronic data processing apparatus according to claim 1,
wherein the medium sorting order detection unit detects the sorting order of the plurality of electronic media in accordance with the order in which the electronic media are connected.

6. The electronic data processing apparatus according to claim 1, further comprising:
a table of contents generation unit configured to generate, based on the data obtained from the plurality of electronic media by the data obtaining unit, a table of contents of each of the data; and
a table of contents display control unit configured to display, in a display unit, the table of contents of each of the data generated by the table of contents generation unit.

7. The electronic data processing apparatus according to claim 6,
wherein the data order specifying unit includes a table of contents order changing unit configured to change an order of the tables of contents of the data displayed by the table of contents display control unit in response to a user operation, and
the data order specifying unit specifies the order of the data according to the order of the tables of contents changed by the table of contents order changing unit.

8. The electronic data processing apparatus according to claim 1,
wherein the electronic medium is an electronic paper that is connected in a detachable and contactless manner and displays display data, the electronic data processing apparatus further comprising:
an operation position detection unit configured to detect an operation position on the electronic paper corresponding to a user operation under a state where the electronic paper is placed; and
an addition superimposition display control unit configured to superimpose and display data corresponding to the user operation position detected by the operation position detection unit on an appropriate position of the electronic paper as additional data.

9. A method used in an electronic data processing apparatus to which a plurality of electronic media is detachably connected, the method comprising the steps of:
obtaining data respectively stored in the plurality of electronic media;
specifying an order of the data obtained from the plurality of electronic media by the obtaining step;
detecting a sorting order of the plurality of electronic media; and
rewriting the data respectively stored in the plurality of electronic media in the order of the data specified by the specifying according to the sorting order of the plurality of electronic media detected by the detecting.
